(19) United States
(12) Patent Application Publication
(10) Pub. No.: US 2025/0079555 A1
(43) Pub. Date: Mar. 6, 2025

(54) Safety, Integrity and Heat Dissipation Design for Fast Charging Super Capacitor Energy Storage

(71) Applicant: Jolta Technologies DMCC, Dubai (AE)

(72) Inventor: Muhammad Usman Sheikh, Dubai (AE)

(21) Appl. No.: 18/459,458

(22) Filed: Sep. 1, 2023

(51) Int. Cl. H01M 10/653; H01G 11/18; H01M 10/04; H01M 10/48; H01M 10/613; H01M 10/635; H01M 10/6555; H01M 10/6563; H01M 50/211; H01M 50/224; H01M 50/264

(52) U.S. Cl. CPC H01M 10/653; H01G 11/18; H01M 10/0481; H01M 10/482; H01M 10/486; H01M 10/613; H01M 10/635; H01M 10/6555; H01M 10/6563; H01M 50/211; H01M 50/224; H01M 50/264

(57) ABSTRACT

Method, for ensuring physical integrity and overheating safety via managed heating dissipation, may employ one or more metallic heat sinks disposed between or next to the supercapacitor cells of a battery pack and these metallic heat sinks connected to the metallic enclosure of a battery pack thus converting the whole enclosure to dispense heat generated inside the battery enclosure. Further, this setup may be create in a way that it ensures physical integrity of each unit by apply encapsulating techniques, assembly and sequence to ensure that each cell remains in its original physical condition (thickness) during the entire life of unit's operation. Further, these 2 functionalities (heat dissipation & physical condition consistency) together ensures lasting safety, physical integrity and operations quality.

### BACKGROUND

This paper presents the design considerations for the safety, integrity, and heat dissipation of fast charging super capacitor energy storage units. Super capacitors are a promising technology for energy storage due to their high power density, long cycle life, and fast charging capabilities. However, the high power density and rapid charging rates can result in safety hazards and thermal management challenges.

To ensure the safe operation of super capacitor storage units, several safety measures need to be implemented. This includes the use of protective circuitry to prevent overvoltage, overcurrent, and overtemperature conditions. Additionally, measures such as short circuit protection and cell balancing techniques should be employed to prevent cell damage and maintain uniform performance across the super capacitor bank.

Integrity of the super capacitor unit involves the design of robust mechanical and electrical connections to withstand the stresses associated with fast charging and discharging cycles. This includes selecting appropriate materials for the construction of the unit and ensuring proper electrical insulation to avoid short circuits or electrical faults.

Heat dissipation is a critical aspect in the design of super capacitor storage units. The high power density during fast charging can generate significant heat, which must be effectively dissipated to prevent thermal runaway and degradation of the super capacitors. Heat sinks, cooling fans, or other thermal management techniques may be employed to maintain safe operating temperatures.

Furthermore, the paper explores various design strategies to enhance the overall performance and reliability of super capacitor storage units. This includes optimizing the charging and discharging algorithms, implementing intelligent control systems, and integrating advanced monitoring and diagnostic capabilities.

By addressing the safety, integrity, and heat dissipation challenges associated with fast charging super capacitor energy storage, this paper aims to contribute to the development of robust and efficient energy storage solutions that can find applications in various domains such as electric vehicles, renewable energy systems, and grid-level energy storage.

Keywords: Super capacitors, energy storage, fast charging, safety, integrity, heat dissipation.

### DESCRIPTION OF DRAWINGS

FIG. 1: When there is current flow at fast charging and discharging through terminals 11 and 12 the surface 10 of nano pouch is heated and during fast charge, gassing effect is produced resulting the swelling and pressure apply on surface 10.

FIG. 2: Pressure plate 21 contains strapping cuts 20 for binding the parallel. Cell in a strap to hold the pressure plate 21 and fixed with stopper 30 of FIG. 3. Pressure plate 21 is fixed at both ends of surface 10 to stop the expansion. Of cell 10 due to gassing. This arrangement allow the gases to be uniform inside of Cell 10. This arrangement also forbids the effect of cell 10 swelling to deform and short the cell 10 Terminals.

FIG. 3: Air Gap 30,31,32,33 ensures the air flow to maximize the contact of area with all the cells 10. Stopper 30 prevents the cell 10 in combination to de-shape or relocate the combination of cells 10 inside the module.

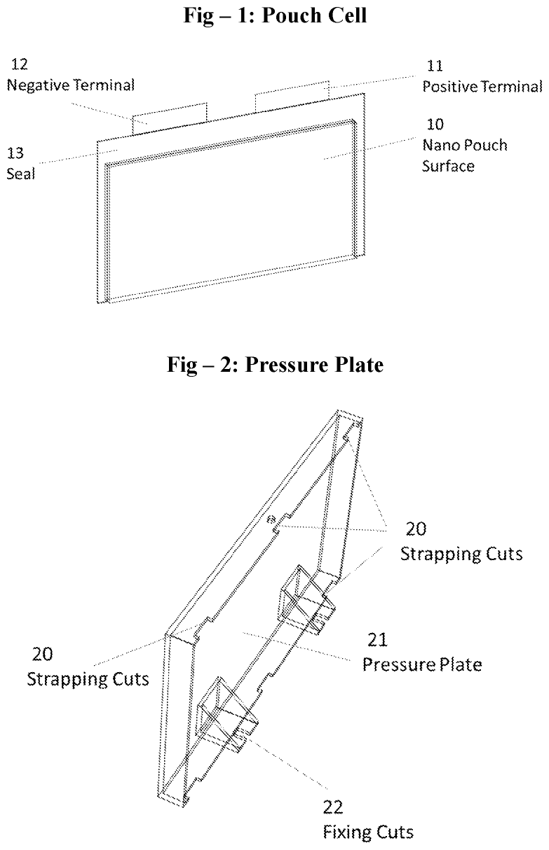

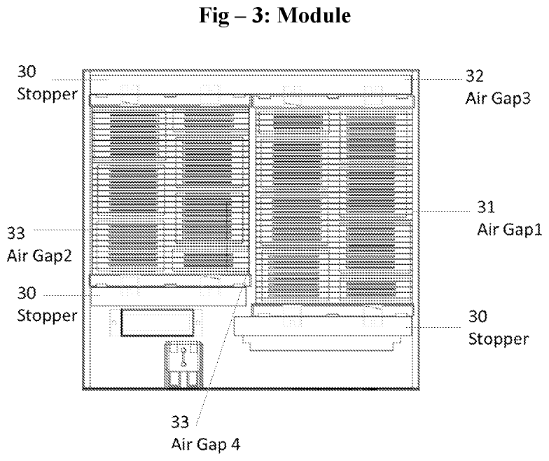

### FIELD OF INVENTION

This present invention relates to creation of 2 different metallic (chemical composition not shared) casings to ensure
1. Exact physical condition management for entire life cycle of cell.
2. Uniformity of assembly, for different configurations.
3. Uniform heat dissipation, throughout the unit.

### DISCLOSURE OF INVENTION

Methods of and apparatus for removing heat generated by cells of a super capacitor battery pack are disclosed. The methods and apparatus may employ one or more metallic heat sinks disposed between or next to cells of the battery pack, and these metallic heat sinks connected to the metallic enclosure of a battery pack thus converting the whole enclosure to dispense heat generated inside the battery enclosure. Additionally, methods are disclosed for ventilation system other critical components of battery pack such as spacing on the sides, top and bottom; ensuring regular air flow for heat dissipation. Methods of assembling the integrated battery pack and thermal and ventilation system are also described.

According to an embodiment of the invention, the thermal management and ventilation and energy storage systems may be housed in a single integrated battery unit (IBU), which can be easily installed in existing electric vehicles, without requiring any substantial modifications to be made to the vehicle. A charge port that is easily accessible by an operator. The charge port avoids having to access the battery pack from under a hood, Finally, a battery mounted display status may be integrated in the IBU. Other aspects of the inventions are described and claimed below, and a further understanding of the nature and advantages of the inventions may be realized by reference to the remaining portions of the specification and the attached drawings. The same reference indicators will be used throughout the drawings to refer to the same or similar parts.

1. Apparatus for removing heat generated by cells of a super capacitor battery pack during a fast charge operation
One or more metallic conductive heat sink disposed between or next to cells of the battery pack
A M.S. Metal Steel based thermal sheet installed between or next to cells & heat sink to distribute heat and help exchange between cells and metallic heat sink.
Compression strip to enhance close connection between cells surface, thermal sheet and metallic heat sink.
Compression strip also help on either side of the cell pack to apply uniform pressure across the cell surface.
Compression plates help keep all cells and its physical state in uniformity throughout the life of the cell.
Assembling an integrated battery unit where Cell packs disclosed in the first embodiment are installed in the metallic battery unit enclosure in a fashion that metallic heat exchanges installed in cell pack are in direct contact with the metallic enclosure.

2. Method of heat management for the energy storage unit to ensure that heat dissipated from the unit is extracted uniformly across the unit.
Plurality of terminal temperature sensors are installed on the charging and discharging terminals of the battery and connected to the main processor.
A plurality of space management fins installed on all sides to create air gaps, shown in FIG. 3.
A plurality of Fan installed on the battery enclosure and connected to the main controller.
Plurality of Cell temperature sensor connected to the main controller through a data bus.
Plurality of ambient temperature sensor installed on the external enclosure of the battery pack and connected to the main controller through a data bus.
Plurality of High current sensor connected with the main controller through a data bus.
